(19) United States
(12) Patent Application Publication
(10) Pub. No.: US 2011/0212408 A1
(43) Pub. Date: Sep. 1, 2011

(54) Buccal tube with square or rectangular auxiliary slot

(76) Inventor: John T. Kalange, Boise, ID (US)

(21) Appl. No.: 12/926,872

(22) Filed: Dec. 15, 2010

Related U.S. Application Data
(60) Provisional application No. 61/286,714, filed on Dec. 15, 2009.

(51) Int. Cl. A61C 7/28

(52) U.S. Cl. 433/17

(57) ABSTRACT

A buccal tube with a square or rectangular auxiliary slot/tube is provided. The square or rectangular auxiliary slot/tube allows for the attachment of auxiliaries of similar shapes, and thus prevents rotation of square or rectangular auxiliary within the buccal tube. An orthodontic auxiliary such as a headgear facebow, which is round, can still be inserted into the square or rectangular buccal tube so long as the size of the headgear facebow is smaller than the smallest inside dimension of the buccal tube.

### RELATED APPLICATIONS

The present application is a continuation-in-part application of U.S. provisional patent application, Ser. No. 61/286,714, filed Dec. 15, 2010, for BUCCAL TUBE WITH SQUARE OR RECTANGULAR AUXILLARY SLOT, by John T. Kalange, included by reference herein and for which benefit of the priority date is hereby claimed.

### FIELD OF THE INVENTION

The present invention relates to buccal tubes placed on orthodontic bands and brackets and, more particularly, to a buccal tube that has a square or rectangular slot that prevents rotation of devices inserted into this slot.

### BACKGROUND OF THE INVENTION

The following text should not be construed as an admission of knowledge in the prior art. Furthermore, citation of identification of any document in this application is not an admission that such document is available as prior art to the present invention, or that any reference forms a part of the common general knowledge in the art.

In the treatment of orthodontic patients, it is frequently quite necessary to place attachments on several of the teeth. These attachments allow for the placement of forces to the jaws for orthopedic correction, and to the teeth which allow for orthodontic tooth movement. One of these attachments is an item which in conventionally called a “Buccal Tube” which is attached to the buccal or cheek-side part of the tooth, and which is a cast metal or milled bracket which is welded to a circular band. This band is fitted and adhered to any of the teeth. In particular, the proposed item would be welded to bands that fit specifically on any of the upper or lower molar teeth, or alternatively, would be directly bonded to the teeth with an acrylic resin. The buccal tube is typically used for receiving another orthodontic device such as a headgear facebow, lip bumper, class II corrector (overbite corrector), archwire, or other device.

The current state of the art employs a buccal tube with two or three slots or tubes, the largest of which is round, and has a diameter of either 0.045, or 0.051 inches. This round slot allows for the insertion of various devices that apply a force, or an attachment point to the tooth such as a headgear facebow. Because the current slot is round, anything placed in the slot is allowed to rotate along the long axis of the slot. Quite frequently, this is an undesirable effect. The remaining slot(s) are much smaller in size and are generally used to accommodate an orthodontic archwire which is of a much smaller dimension.

The currently proposed patent application, includes a Buccal Tube with a larger diameter square or rectangular slot (in place of the round one), that allows for not only the insertion of round items, but square or rectangular devices as well. The advantage of using a square or rectangular device inserted into a square or rectangular slot, is that it prevents the rotation of the device which in inserted into the slot.

Previous inventors have broached the idea of using square, rectangular, or other geometric designs in buccal tube applications'. Specifically, U.S. Pat. No. 4,963,092 by Wolford describes a buccal tube appliance for round or rectangular wire. However, this design is limited to the use of an orthodontic archwire only, and does not provide for the use of auxiliaries which are specifically designed to fit in the headgear tube designated with 0.045 or 0.051 inch dimensions. U.S. Pat. No. 4,781,582 by Kessling describes a convertible buccal tube assembly that provides for a covering that converts a round slot into a rectangular opening. This design however, does not incorporate the idea of a rectangular, square or other geometric shape running the entire length of the tube. Also the Kessling design is intended for the use of an archwire only, and does not contemplate the use of some of the auxiliaries previously described. U.S. Pat. No. 5,320,526 by Tuneberg describes a buccal tube appliance in which an insert is placed in an existing round buccal tube, which converts it to a rectangular tube. However, as in other designs, this design reduces the size of the tube to the size of an orthodontic archwire, and does not allow for larger auxiliaries to be placed which are in the range of 0.045 to 0.052 inches.

### SUMMARY OF THE INVENTION

The shortcomings of the prior art discussed above are addressed by the various embodiments of the present invention. It is to be understood that the present invention includes a variety of different versions or embodiments, and this Summary is not meant to be limiting or all-inclusive. This Summary provides some general descriptions of some of the embodiments, but may also include some more specific descriptions of certain embodiments.

In accordance with the embodiments of the present invention, an appliance comprises a base designed for at least one of direct or indirect attachment to the tooth, and at least one slot of the dimension 0.045 or 0.052 inches or similar dimension. This slot would be made available for the attachment of multiple auxiliaries.

In accordance with the embodiments of the present invention, a buccal tube with a square or rectangular shape is provided. The square or rectangular buccal tube allows for the attachment of axillaries of similar shapes, and thus prevents rotation of square or rectangular auxiliary within the buccal tube.

Thus, in accordance with embodiments of the present invention, an orthodontic auxiliary such as a headgear facebow, which is round can still be inserted into the square or rectangular buccal tube so long as the size of the headgear facebow is smaller than the smallest inside dimension of the buccal tube.

In another embodiment of the invention, a buccal tube for attachment to a tooth is provided, the buccal tube comprising a base, two archwire slots, and a larger rectangular or square slot which is oriented towards the gingival (gum) side of the tooth, for the acceptance of a plurality of auxiliary devices. These auxiliary devices would be of the same geometry of the larger slot, and as such, would not be able to rotate within this slot.

In yet another embodiment of the invention, a buccal tube for attachment to a tooth is provided, the buccal tube comprising a base, two archwire slots, and a larger rectangular or square slot which is oriented towards the occlusal (biting side) of the tooth, for the acceptance of a plurality of auxiliary devices. These auxiliary devices would be of the same geometry of the larger slot, and as such, would not be able to rotate within this slot.

In accordance with the embodiments of the present invention, a buccal tube for attachment to a tooth is provided, the buccal tube comprising a base, a single archwire slot, and a larger rectangular or square slot which is oriented towards the gingival, or the occlusal side of the tooth, for the acceptance of a plurality of auxiliary devices. These auxiliary devices would be of the same geometry of the larger slot, and as such, would not be able to rotate within this slot.

In yet another embodiment of the invention, a buccal tube for attachment to a tooth is provided, the buccal tube comprising a base, and no archwire slot. This would provide a single larger rectangular or square slot which is oriented towards the gingival, or the occlusal side of the tooth, for the acceptance of a plurality of auxiliary devices. These auxiliary devices would be of the same geometry of the larger slot, and as such, would not be able to rotate within this slot.

In another embodiment of the invention, a buccal tube for attachment to a tooth is provided, the buccal tube comprising a base, a single archwire slot, and a larger rectangular or square slot which is oriented towards the buccal (cheek side) of the tooth, for the acceptance of a plurality of auxiliary devices. These auxiliary devices would be of the same geometry of the larger slot, and as such, would not be able to rotate within this slot.

In accordance with the embodiment of the invention, a buccal tube for attachment to a tooth is provided, the buccal tube comprising a base, two archwire slots, and a larger hexagonal or other geometrically shaped slot, for the acceptance of a plurality of auxiliary devices. These auxiliary devices would be of the same or similar geometry of the larger slot, and as such, would not be able to rotate within this slot.

In another embodiment of the invention, a buccal tube for attachment to a tooth is provided, the buccal tube comprising a base, two archwire slots, and a triangular shaped slot, for the acceptance of a plurality of auxiliary devices. These auxiliary devices would be of the same or similar geometry of the larger slot, and as such, would not be able to rotate within this slot.

In accordance with the embodiment of the invention, a buccal tube for attachment to a tooth is provided, any configuration of slot shape of the larger slot, would still allow for the insertion of the standard auxiliary attachments intended for a round 0.045 or 0.052 inch tube.

Other aspects of various embodiments not summarized here are also considered to form a part of the present invention, either alone or in combination with other aspects.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A,B, and C”, “one or more of A,B, or C” and “A, B, and/or C” means A alone, B alone, C alone, A and B together, A and C together, B and C together, or A, B and C together.

It is to be noted that the term “a” or “an entity refers to one or more of that entity. As such, the terms “a” (or “an”), “one or more” and “at least one” can be used interchangeably herein. It is also to be noted that the terms “comprising”, “including”, and “having” can be used interchangeably.

Various embodiments of the present invention are set forth in the attached figures and in the detailed description of the invention as provided herein and as embodied by the claims. It should be understood, however, that this Summary does not contain all of the aspects and embodiments of the present invention, is not meant of be limiting or restrictive in any manner, and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a mesial (front) view of an orthodontic appliance in accordance with embodiments of the present invention;

FIG. 2 is a distal (back) view of the device shown in FIG. 1;

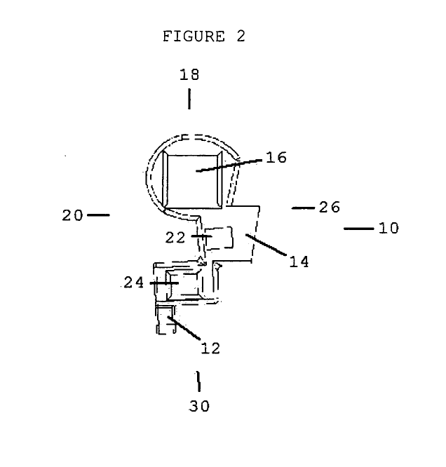

FIG. 3 is a perspective view of the devices shown in FIGS. 1 and 2;

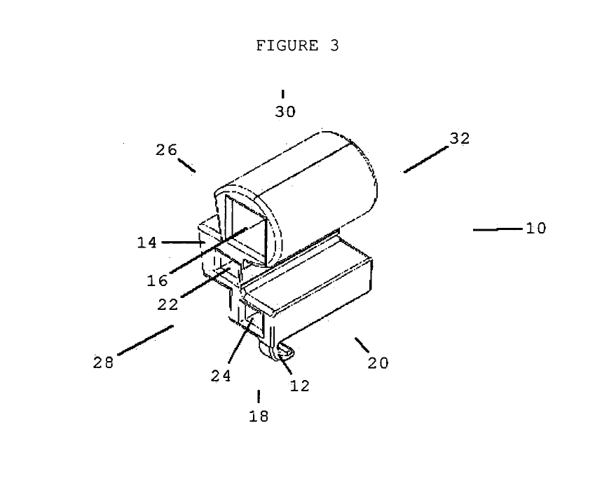

FIG. 4 is a mesial (front) view of an embodiment of the present invention;

FIG. 5 is a distal (back) view of the device in FIG. 4;

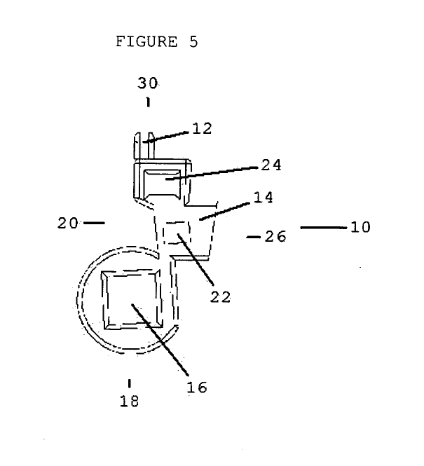

FIG. 6 is a perspective view of the devices in FIGS. 4 and 5;

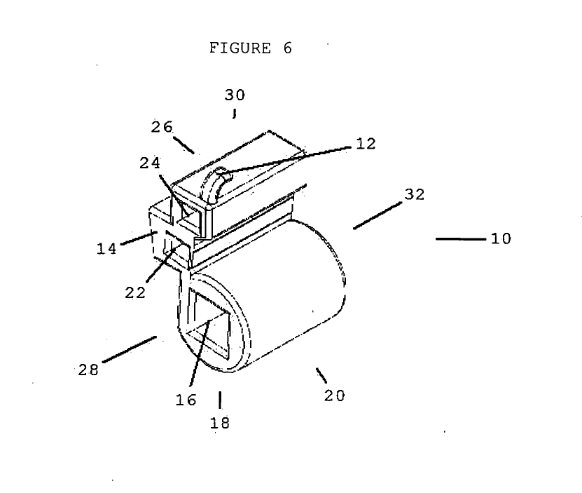

FIG. 7 is a mesial (front) view of an orthodontic appliance in accordance with embodiments of the invention;

FIG. 8 is a distal (back) view of the device in FIG. 7;

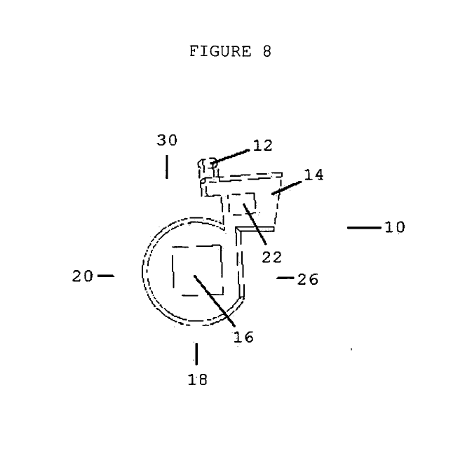

FIG. 9 is a perspective view of the devices in FIGS. 7 and 8;

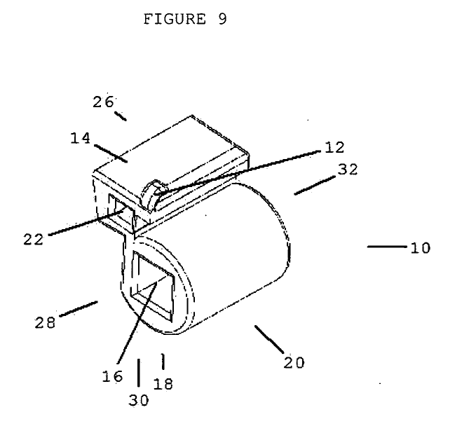

FIG. 10 is a mesial (front) view of an orthodontic appliance in accordance with an embodiment of the present invention;

FIG. 11 is a distal (back) view of the design in FIG. 10;

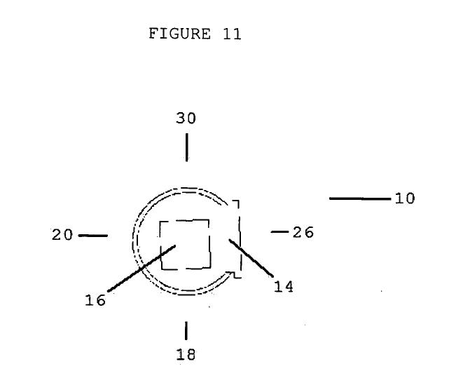

FIG. 12 is a perspective view of the devices in FIGS. 10 and 11;

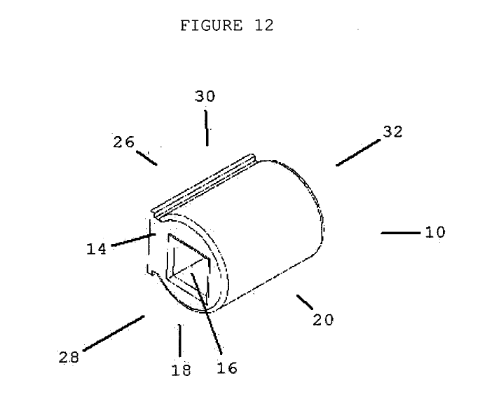

FIG. 13 is a mesial (front) view of an orthodontic appliance in accordance with an embodiment of the present invention;

FIG. 14 is a distal (back) view of the design in FIG. 13;

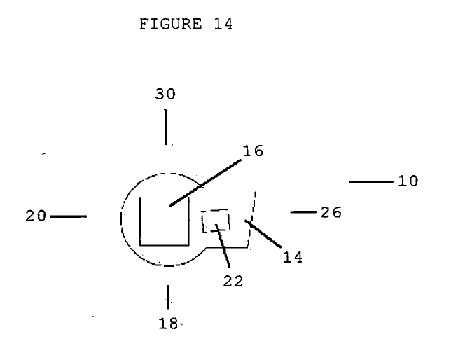

FIG. 15 is a perspective view of the designs in FIGS. 13 and 14;

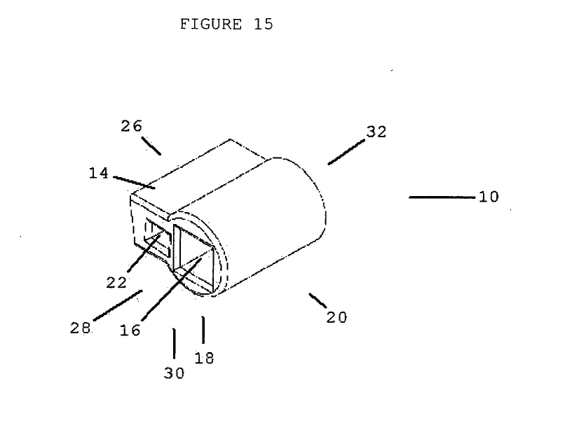

FIG. 16 is a mesial (front) view of an orthodontic appliance in accordance with an embodiment of the present invention;

FIG. 17 is a distal (back) view of the design in FIG. 16;

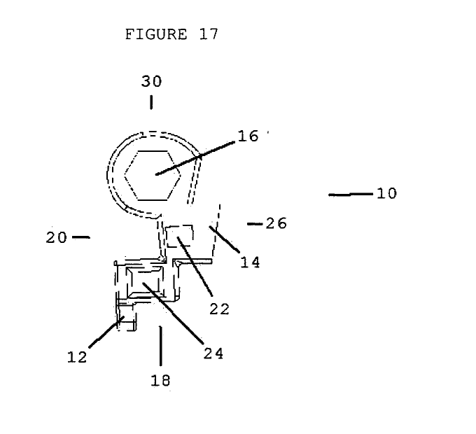

FIG. 18 is a perspective view of the designs in FIGS. 16 and 17;

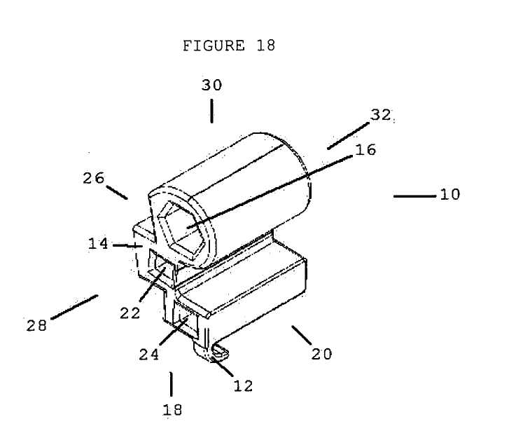

FIG. 19 is a mesial (front) view of an orthodontic appliance in accordance with an embodiment of the present invention;

FIG. 20 is a distal (back) view of the device in FIG. 19; and

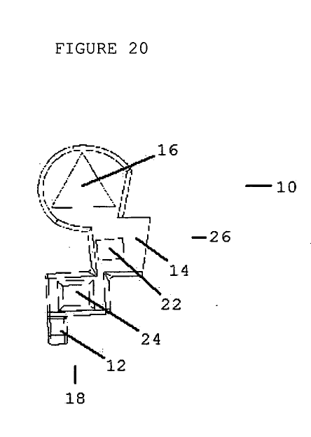

FIG. 21 is a perspective view of the devices in FIGS. 19 and 20.

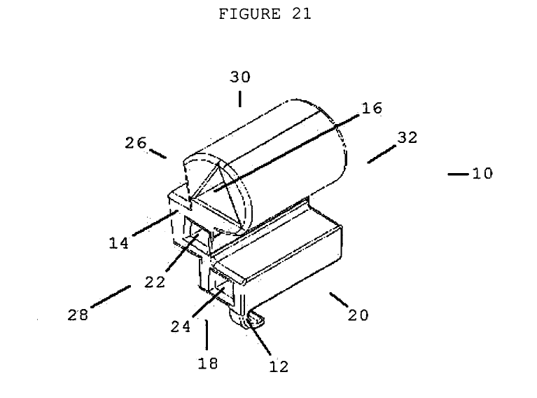

For purposes of clarity and brevity, like elements and components will bear the same designations and numbering throughout the Figures.

### DESCRIPTION OF THE PREFERRED EMBODIMENT

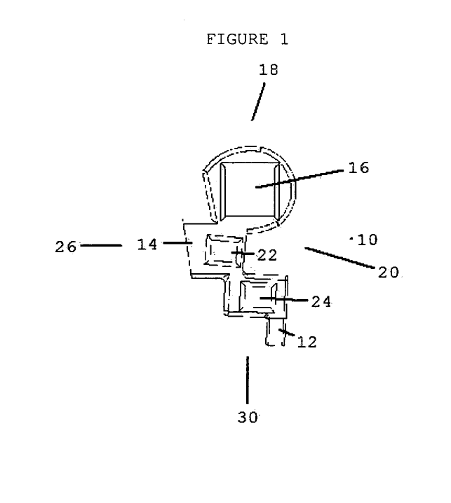

FIG. 1 is a mesial (front) view of an orthodontic appliance in accordance with embodiments of the present invention. The buccal tube 10 provides for auxiliary slot/tube 16 which allows for the insertion of various auxiliaries. For example, the buccal tube 10 has a rectangular opening that allows for the insertion of a plurality of devices. This rectangular opening would have a side dimension of either 0.051 or 0.045 inch or similar dimension. If the auxiliary is of the same dimension as the auxiliary slot/tube 16, rotation of this auxiliary device would be prevented. For instance, a class II corrector could be placed into this rectangular slot beginning from the mesial end 28, and extending through the slot/tube and ending on the distal end 32. If the portion of the class II corrector that is inserted into the auxiliary slot/tube 16 is rectangular, it would prevent rotation of the device towards the occlusal side 18 or towards the gingival side 30. If the device were allowed to rotate towards the occlusal side 18 it could result in tissue impingement or it could interfere with chewing and biting. If the device were allowed to rotate towards the gingival side 30, it could also result in tissue impingement. In addition, as can be appreciated by those skilled in the art, it is to be understood that the present invention is applicable to a buccal tube 10 having additional slots in addition to the auxiliary slot/tube 16. These additional slots include the main archwire slot 22, and the auxiliary archwire slot 24. These archwire slots are generally reserved for the insertion of orthodontic archwires which are of a significantly smaller dimension that devices that are inserted into the auxiliary slot/tube 16.

The use of multiple archwire slots in addition to an auxiliary slot/tube 16 allows the treating orthodontist to apply a single buccal tube 10 to the patients tooth, and utilize either one or more of slots and/or the auxiliary slot/tube 16 during various phases of orthodontic treatment. Among its uses, the different slots/tubes allow for the application of force/torque to be applied to the tooth.

For the buccal tube 10 shown in FIG. 1, a base 14 is provided which can be welded or soldered to an orthodontic band. Additionally, this base 14 could be bonded directly to the tooth in the form of a conventional orthodontic bracket. In addition to having the traditional components of an orthodontic buccal tube 10, the proposed invention would also include a hook 12 for the attachment of elastics and similar devices.

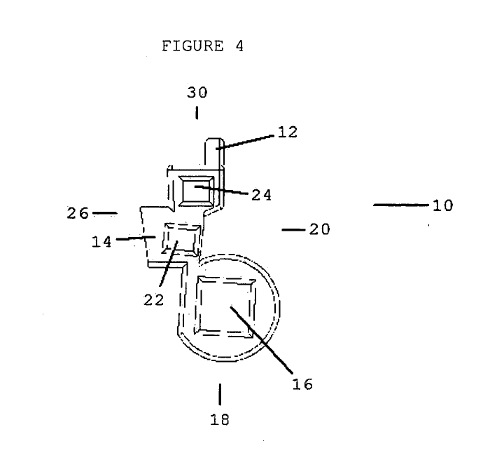

Referring now to FIG. 4 is a mesial (front) view of an embodiment of the present invention. The buccal tube 10 provides for auxiliary slot/tube 16 which allows for the insertion of various auxiliaries. The auxiliary slot/tube 16 in this embodiment has the auxiliary slot/tube 16 oriented towards the occlusal side 18. For example, the buccal tube 10 has a rectangular opening that allows for the insertion of a plurality of devices. This rectangular opening would have a side dimension of either 0.051 or 0.045 or similar dimension. If the auxiliary is of the same dimension as the auxiliary slot/tube 16, rotation of this auxiliary device would be prevented. For instance, a headgear or lip bumper could be placed into this rectangular slot beginning from the mesial end 28, and extending through the slot/tube and ending on the distal end 32. If the portion of the headgear or lip bumper that is inserted into the auxiliary slot/tube 16 is rectangular, it would prevent rotation of the device towards the occlusal side 18 or towards the gingival side 30. If the device were allowed to rotate towards the occlusal side 18 it could result in tissue impingement or it could interfere with chewing and biting. If the device were allowed to rotate towards the gingival side 30, it could also result in tissue impingement. In addition, as can be appreciated by those skilled in the art, it is to be understood that the present invention is applicable to a buccal tube 10 having additional slots in addition to the auxiliary slot/tube 16. These additional slots include the main archwire slot 22, and the auxiliary archwire slot 24. These archwire slots are generally reserved for the insertion of orthodontic archwires which are of a significantly smaller dimension that devices that are inserted into the auxiliary slot/tube 16.

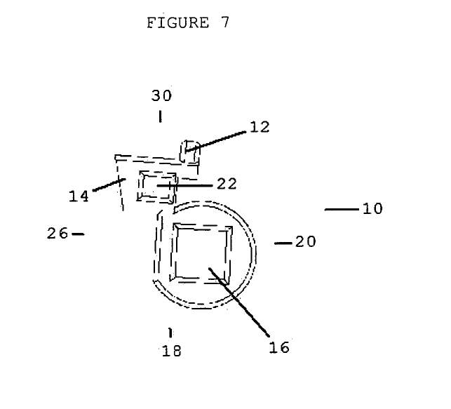

FIG. 7 is a mesial (front) view of an orthodontic appliance in accordance with embodiments of the invention. The present invention includes an auxiliary slot/tube 16 which can be oriented either to the occlusal side 18, or to the gingival side 30. The buccal tube 10 provides for auxiliary slot/tube 16 which allows for the insertion of various auxiliaries. The auxiliary slot/tube 16 in this embodiment has the auxiliary slot/tube 16 oriented towards the occlusal side 18. For example, the buccal tube 10 has a rectangular opening that allows for the insertion of a plurality of devices. This rectangular opening would have a side dimension of either 0.051 or 0.045 or similar dimension. If the auxiliary is of the same dimension as the auxiliary slot/tube 16, rotation of this auxiliary device would be prevented. For instance, a class II corrector could be placed into this rectangular slot beginning from the mesial end 28, and extending through the slot/tube and ending on the distal end 32. If the portion of the class II corrector that is inserted into the auxiliary slot/tube 16 is rectangular, it would prevent rotation of the device towards the occlusal side 18 or towards the gingival side 30. If the device were allowed to rotate towards the occlusal side 18 it could result in tissue impingement or it could interfere with chewing and biting. If the device were allowed to rotate towards the gingival side 30, it could also result in tissue impingement. In addition, as can be appreciated by those skilled in the art, it is to be understood that the present invention is applicable to a buccal tube 10 having at least one additional slot in addition to the auxiliary slot/tube 16 and may not have an auxiliary archwire slot 24. This additional slot would include the main archwire slot 22. This archwire slot generally is reserved for the insertion of orthodontic archwires which are of a significantly smaller dimension than devices that are inserted into the auxiliary slot/tube 16.

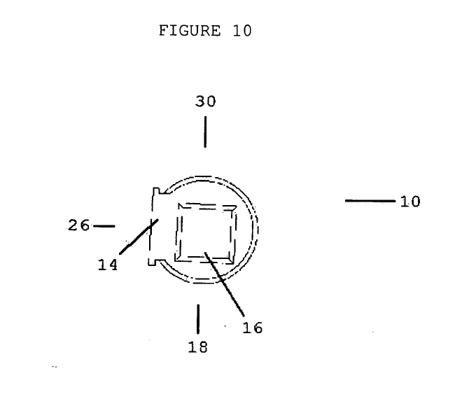

FIG. 10 is a mesial (front) view of an orthodontic appliance in accordance with an embodiment of the present invention. The present invention includes an auxiliary slot/tube 16 which is oriented towards the buccal side 20 in relationship to the base 14 which is oriented to the lingual side 26. The buccal tube 10 provides for auxiliary slot/tube 16 which allows for the insertion of various auxiliaries. The auxiliary slot/tube 16 in this embodiment has the auxiliary slot/tube 16 oriented towards the buccal side 20. For example, the buccal tube 10 has a rectangular opening that allows for the insertion of a plurality of devices. This rectangular opening would have a side dimension of either 0.051 or 0.045 or similar dimension. If the auxiliary is of the same dimension as the auxiliary slot/tube 16, rotation of this auxiliary device would be prevented. For instance, a labial bow could be placed into this rectangular slot beginning from the mesial end 28, and extending through the slot/tube and ending on the distal end 32. If the portion of the labial bow that is inserted into the auxiliary slot/tube 16 is rectangular, it would prevent rotation of the device towards the occlusal side 18 or towards the gingival side 30. If the device were allowed to rotate towards the occlusal side 18 it could result in tissue impingement or it could interfere with chewing and biting. If the device were allowed to rotate towards the gingival side 30, it could also result in tissue impingement. In addition, as can be appreciated by those skilled in the art, it is to be understood that the present invention is applicable to a buccal tube 10 having no main archwire slot 22 or an auxiliary archwire slot 24, but the 0.052 or 0.045 inch or similarly sized slot.

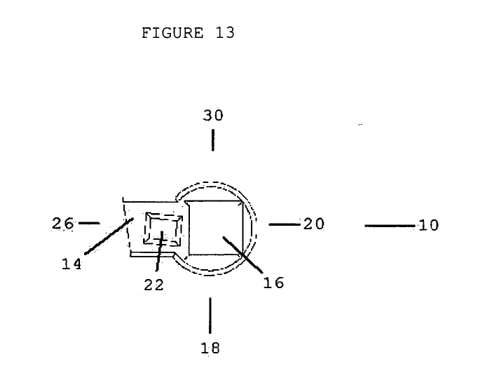

FIG. 13 is a mesial (front) view of an orthodontic appliance in accordance with an embodiment of the present invention. The present invention includes an auxiliary slot/tube 16 which is oriented either to the buccal side 20, with the main archwire slot 22 being oriented towards the lingual side 26. The buccal tube 10 provides for auxiliary slot/tube 16 which allows for the insertion of various auxiliaries. The auxiliary slot/tube 16 in this embodiment has the auxiliary slot/tube 16 oriented towards the occlusal side 18. For example, the buccal tube 10 has a rectangular opening that allows for the insertion of a plurality of devices. This rectangular opening would have a side dimension of either 0.051 or 0.045 or similar dimension. If the auxiliary is of the same dimension as the auxiliary slot/tube 16, rotation of this auxiliary device would be prevented. For instance, a class II corrector could be placed into this rectangular slot beginning from the mesial end 28, and extending through the slot/tube and ending on the distal end 32. If the portion of the class II corrector that is inserted into the auxiliary slot/tube 16 is rectangular, it would prevent rotation of the device towards the occlusal side 18 or towards the gingival side 30. If the device were allowed to rotate towards the occlusal side 18 it could result in tissue impingement or it could interfere with chewing and biting. If the device were allowed to rotate towards the gingival side 30, it could also result in tissue impingement. In addition, as can be appreciated by those skilled in the art, it is to be understood that the present invention is applicable to a buccal tube 10 having at least one additional slot in addition to the auxiliary slot/tube 16 and may not have an auxiliary archwire slot 24. This additional slot would include the main archwire slot 22. This archwire slot generally is reserved for the insertion of orthodontic archwires which are of a significantly smaller dimension than devices that are inserted into the auxiliary slot/tube 16.

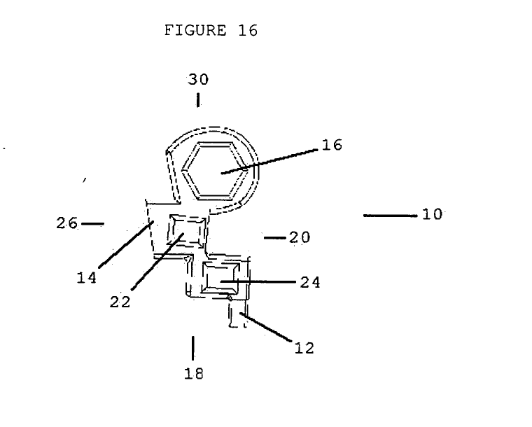

FIG. 16 is a mesial (front) view of an orthodontic appliance in accordance with an embodiment of the present invention. The buccal tube 10 provides for auxiliary slot/tube 16 which allows for the insertion of various auxiliaries. For example, the buccal tube 10 has a hexagonal, opening that allows for the insertion of a plurality of devices. This hexagonal opening would have a minimum inside dimension of either 0.051 or 0.045 or similar dimension. If the auxiliary is of the same dimension as the auxiliary slot/tube 16, rotation of this auxiliary device would be prevented. For instance, a class II corrector could be placed into this hexagonal slot beginning from the mesial end 28, and extending through the slot/tube and ending on the distal end 32. If the portion of the class II corrector that is inserted into the auxiliary slot/tube 16 is hexagonal, it would prevent rotation of the device towards the occlusal side 18 or towards the gingival side 30. If the device were allowed to rotate towards the occlusal side 18 it could result in tissue impingement or it could interfere with chewing and biting. If the device were allowed to rotate towards the gingival side 30, it could also result in tissue impingement. In addition, as can be appreciated by those skilled in the art, it is to be understood that the present invention is applicable to a buccal tube 10 having additional slots in addition to the auxiliary slot/tube 16. These additional slots include the main archwire slot 22, and the auxiliary archwire slot 24. These archwire slots are generally reserved for the insertion of orthodontic archwires which are of a significantly smaller dimension that devices that are inserted into the auxiliary slot/tube 16.

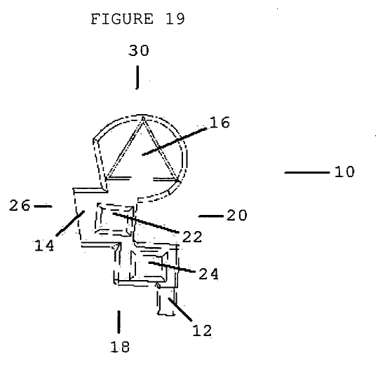

FIG. 19 is a mesial (front) view of an orthodontic appliance in accordance with an embodiment of the present invention. The buccal tube 10 provides for auxiliary slot/tube 16 which allows for the insertion of various auxiliaries. For example, the buccal tube 10 has a triangular or any other polygonal shaped opening that allows for the insertion of a plurality of devices. This triangular or any other polygonal shaped opening would have a minimum dimension of either 0.051 or 0.045 or similar dimension. If the auxiliary is of the same dimension as the auxiliary slot/tube 16, rotation of this auxiliary device would be prevented. For instance, a class II corrector could be placed into this triangular slot beginning from the mesial end 28, and extending through the slot/tube and ending on the distal end 32. If the portion of the class II corrector that is inserted into the auxiliary slot/tube 16 is triangular, it would prevent rotation of the device towards the occlusal side 18 or towards the gingival side 30. If the device were allowed to rotate towards the occlusal side 18 it could result in tissue impingement or it could interfere with chewing and biting. If the device were allowed to rotate towards the gingival side 30, it could also result in tissue impingement. In addition, as can be appreciated by those skilled in the art, it is to be understood that the present invention is applicable to a buccal tube 10 having additional slots in addition to the auxiliary slot/tube 16. These additional slots include the main archwire slot 22, and the auxiliary archwire slot 24. These archwire slots are generally reserved for the insertion of orthodontic archwires which are of a significantly smaller dimension that devices that are inserted into the auxiliary slot/tube 16.

In any embodiment of the invention, a round headgear facebow, a round class II corrector, or any other similar device can be still inserted into the auxiliary slot/tube 16 as if it were a conventional round 0.052 or 0.045 inch or similarly shaped round opening.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A buccal tube with square or rectangular auxiliary slot for the insertion of various devices that facilitates the application of forces to be placed on the teeth and jaws, comprising:
means for the placement of forces to the jaws for orthopedic correction, and to the teeth which allows for orthodontic tooth movement;
means for attaching elastics, elastomeric devices or other related devices;
means for attaching to an orthodontic band, or for bonding directly to a tooth;
means for insertion of various devices that apply a force to the jaws, or as an attachment point to the tooth or teeth for receiving a device such as a headgear facebow, lip bumper, class II corrector (overbite corrector), or other device which is generally in the measurement range of 0.045 or 0.052 inches or similar size. placement of an auxiliary with the same or similar geometry will prevent rotation of this auxiliary within the auxiliary slot/tube;
means for the side representing the biting side;
means for the side representing the cheek side;
means for representing the gum side;
means for acceptance of the main archwire which is generally used in the leveling and alignment of teeth and brackets along this archwire. this archwire slot being of the dimension of 0.018×0.025 or 0.022×0.028 inches or similar dimensions;
means for acceptance of an additional auxiliary archwire for the leveling and alignment of teeth and brackets along this archwire. the archwire slot being of the dimension of 0.018×0.025 or 0.022×0.28 inches or similar dimension;
means for representing the tongue side;
means for the end in which archwires or auxiliary devices are installed; and
means for the end in which the auxiliaries or archwires terminate.

2. The buccal tube with square or rectangular auxiliary slot in accordance with claim 1, wherein said means for the placement of forces to the jaws for orthopedic correction, and to the teeth which allows for orthodontic tooth movement comprises a buccal tube.

3. The buccal tube with square or rectangular auxiliary slot in accordance with claim 1, wherein said means for attaching elastics, elastomeric devices or other related devices comprises a hook.

4. The buccal tube with square or rectangular auxiliary slot in accordance with claim 1, wherein said means for attaching to an orthodontic band, or for bonding directly to a tooth comprises a base.

5. The buccal tube with square or rectangular auxiliary slot in accordance with claim 1, wherein said means for insertion of various devices that apply a force to the jaws, or as an attachment point to the tooth or teeth for receiving a device such as a headgear facebow, lip bumper, class II corrector (overbite corrector), or other device which is generally in the measurement range of 0.045 or 0.052 inches or similar size. placement of an auxiliary with the same or similar geometry will prevent rotation of this auxiliary within the auxiliary slot/tube comprises an auxiliary slot/tube.

6. The buccal tube with square or rectangular auxiliary slot in accordance with claim 1, wherein said means for acceptance of the main archwire which is generally used in the leveling and alignment of teeth and brackets along this archwire. this archwire slot being of the dimension of 0.018×0.025 or 0.022×0.028 inches or similar dimensions comprises a main archwire slot.

7. The buccal tube with square or rectangular auxiliary slot in accordance with claim 1, wherein said means for acceptance of an additional auxiliary archwire for the leveling and alignment of teeth and brackets along this archwire. the archwire slot being of the dimension of 0.018×0.025 or 0.022×0.28 inches or similar dimension comprises an auxiliary archwire slot.

8. The buccal tube with square or rectangular auxiliary slot in accordance with claim 1, wherein said means for the end in which archwires or auxiliary devices are installed comprises a mesial end.

9. The buccal tube with square or rectangular auxiliary slot in accordance with claim 1, wherein said means for the end in which the auxiliaries or archwires terminate comprises a distal end.
